(19) United States
(12) Patent Application Publication
(10) Pub. No.: US 2026/0320120 A1
(43) Pub. Date: Oct. 15, 2026

(54) METHOD AND DEVICE FOR DISPLAYING SEARCH RESULT

(71) Applicant: Samsung Electronics Co., Ltd., Suwon-si (KR)

(72) Inventors: Liheng ZHANG, Guangzhou (CN); Suxian ZHANG, Guangzhou (CN); Peilian CHEN, Guangzhou (CN); Jiahao KANG, Guangzhou (CN); Liangzhi HUANG, Guangzhou (CN)

(21) Appl. No.: 19/703,411

(22) Filed: Jun. 10, 2026

Related U.S. Application Data
(63) Continuation of application No. PCT/KR2024/021141, filed on Dec. 26, 2024.

(30) Foreign Application Priority Data
Jan. 15, 2024 (CN) 202410066230.1

(51) Int. Cl. G06F 16/738; G06F 3/14; G06T 11/60

(52) U.S. Cl. CPC G06F 16/738; G06F 3/1454; G06T 11/60; G06T 2200/24

(57) ABSTRACT

A method and a device for displaying a search result are provided. The method performed by a first electronic device for displaying a search result includes creating a virtual screen for displaying a search object and a search result, in response to receiving a search input while displaying a page of a first application, recording and encoding the virtual screen to generate a video stream, and sending the video stream to a second electronic device, for displaying on the second electronic device, and thus, the search result display in a manner of searching while playing is realized at the first electronic device.

### CROSS-REFERENCE TO RELATED APPLICATIONS

This application is a continuation of International Application No. PCT/KR 2024/021141 designating the United States, filed on Dec. 26, 2024, in the Korean Ministry of Intellectual Property Receiving Office and claiming priority to Chinese Patent Application No. 202410066230.1, filed on Jan. 15, 2024, in the Chinese National Intellectual Property Administration, the disclosures of each of which are incorporated by reference herein in their entireties.

### BACKGROUND

### Field

The disclosure relates to the field of display technology. For example, the present disclosure relates to a method and a device for displaying a search result.

### Description of Related Art

With an increasing popularity of tablet PCs and cell phones, couples, family members, and friends often use tablets to watch movies/videos together during their leisure time, and while enjoying family and friendship together, they will also want to pursue their own personal viewing experience.

Almost everyone has had the experience of watching a video with friends or family. When you see a person or an object of interest in the video, at this time if you want to search for the content of a certain screen, the current video will be paused, the screen will switch to the search results, and the video will resume to play after the search result is checked, which affects the viewing experience of another person who is not interested in the search content.

### SUMMARY

According to an example embodiment of the disclosure, a method, performed by a first electronic device comprising at least one first processor, comprising processing circuitry, for displaying a search result is provided. The method may include: receiving, by the first electronic device, a search input while displaying a page of an application on the first electronic device; creating, by the first electronic device, in response to receiving the search input, a virtual screen for displaying a target object and a search result; encoding the virtual screen to generate a video stream; transmitting, the video stream to a second electronic device for displaying interface information related to the virtual screen on the second electronic device.

According to an example embodiment of the disclosure, a method, performed, by a second electronic device, comprising at least one second processor, comprising processing circuitry, for displaying a search result is provided. The method may include: receiving, by the second electronic device, a video stream related to a virtual screen from a first electronic device; decoding the received video stream; and playing the decoded video stream on the second electronic device.

According to an example embodiment of the disclosure, a first electronic device for displaying a search result is provided. The first electronic device may include at least one first processor comprising processing circuitry, wherein at least one first processor, individually and/or collectively, may be configured to cause the first electronic device to: receive a search input while displaying a page of an application on the first electronic device; create a virtual screen for displaying a target object and a search result in response to receiving the search input; encode the virtual screen to generate a video stream; and transmit the video stream to a second electronic device for displaying interface information related to the virtual screen on the second electronic device.

According to an example embodiment of the disclosure, a second electronic device for displaying a search result is provided. The second electronic device may include at least one second processor, comprising processing circuitry, wherein at least one second processor, individually and/or collectively, is configured to cause the second electronic device to: receive a video stream related to a virtual screen from a first electronic device; decode the received video stream; and play the decoded video stream on the second electronic device.

According to an example embodiment of the disclosure, a method, performed by a first electronic device, for displaying a search result is provided. The method may include: creating, in response to receiving a search operation while displaying a page of a first application, a virtual screen for displaying a search object and a search result; recording and encoding the virtual screen to generate a video stream; and sending the video stream to a second electronic device for displaying on the second electronic device.

According to an example embodiment of the disclosure, a method, performed by a second electronic device, for displaying a search result is provided. The method may include: receiving a video stream related to a virtual screen, sent by a first electronic device; and decoding and playing the video stream.

According to an example embodiment of the disclosure, a first electronic device for displaying a search result is provided. The first electronic device may include a virtual screen creating unit comprising circuitry configured to cause the first electronic device to create, in response to receiving a search operation while displaying a page of a first application, a virtual screen for displaying a search object and a search result; a virtual screen processing unit comprising circuitry configured to cause the first electronic device to record and encode the virtual screen to generate a video stream; and a virtual screen sending unit comprising circuitry configured to cause the first electronic device to send the video stream to a second electronic device for displaying on the second electronic device.

According to an example embodiment of the disclosure, a second electronic device for displaying a search result is provided. The second electronic device may include: a video stream receiving unit comprising circuitry configured to receive a video stream related to the virtual screen, sent by a first electronic device; and a video stream playing unit comprising circuitry configured to cause the second electronic device to decode and play the video stream.

According to an example embodiment of the disclosure, a computer device for displaying a search result is provided. The computer device may include at least one processor, comprising processing circuitry, and at least one memory storing a computer program, wherein the computer program when executed by at least one processor, individually and/or collectively, causes an electronic device to perform a method for displaying the search result.

According to an example embodiment of the disclosure, a non-transitory computer-readable storage medium storing a computer program, is provided, wherein, the computer program when executed by at least one first processor, comprising processing circuitry, individually and/or collectively, of the first electronic device, causes the first electronic device to perform a method according to an example embodiment of the disclosure.

According to an example embodiment of the disclosure, a non-transitory computer-readable storage medium storing a computer program, is provided, wherein, when the computer program is executed by at least one second processor, comprising processing circuitry, individually and/or collectively, of the second electronic device, causes the second electronic device to perform the method according to an embodiment of the disclosure.

Additional aspects and/or advantages of the general concept of the present disclosure will be partially explained in the following description, and still others will be clear from the description, or may be known through the implementation of the general concept of the present disclosure.

### BRIEF DESCRIPTION OF THE DRAWINGS

The above and other aspects, features and advantages of certain example embodiments of the present disclosure will be more apparent from the following detailed description, taken in conjunction with the accompanying drawings in which:

FIG. 1A is a diagram illustrating an example of displaying a search result according to various example embodiments;

FIG. 1B is a diagram illustrating an example of displaying a search result according to various example embodiments;

FIG. 2 is a flowchart illustrating an example method, performed by a first electronic device, for displaying a search result according to various example embodiments;

FIG. 3 is a flowchart illustrating an example method, performed by a second electronic device, for displaying a search result according to various example embodiments;

FIG. 4 is a diagram illustrating an example of displaying a search result by the first electronic device and the second electronic device according to various example embodiments;

FIG. 5 is a block diagram illustrating an example configuration of the first electronic device for displaying a search result according to various example embodiments;

FIG. 6 is a block diagram illustrating an example configuration of the second electronic device for displaying a search result according to various example embodiments;

FIG. 7 is a block diagram illustrating example configurations of the first electronic device and the second electronic device according to various example embodiments;

FIG. 8 is a flowchart illustrating an example method of operating the first electronic device for displaying a search result according to various example embodiments; and

FIG. 9 is a flowchart illustrating an example method of operating the second electronic device for displaying a search result according to various example embodiments.

### DETAILED DESCRIPTION

Reference will be made to various example embodiments of the present disclosure, examples of which are illustrated in the drawings, wherein like reference numerals refer to like elements throughout the drawings.

The terms used in the present disclosure will be briefly described, and then example embodiments of the present disclosure will be described in greater detail.

The terms used in the present disclosure are general terms as much as possible and have been widely used nowadays in consideration of the functions of the present disclosure, which, however, may be changed according to an intention of a technician in the art, a precedent, the advent of new technologies, or the like. Some cases may include arbitrary selected terms, and in this case, the meaning of the terms will be described in detail in the corresponding description. Therefore, the terms used in the present disclosure should be defined based on the meanings of the terms and the content throughout the present disclosure, rather than simply based on the titles of the terms.

The terms “transmit,” “receive,” and “communicate,” as well as derivatives thereof, encompass both direct and indirect communication. The terms “include” and “comprise,” as well as derivatives thereof, may refer to inclusion without limitation. The term “or” is inclusive, meaning and/or. The phrase “associated with,” as well as derivatives thereof, may refer to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below may be implemented or supported by one or more computer programs, each of which is formed from a computer readable program code and embodied in a non-transitory computer-readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,”, “include,” or “may include” a feature (like a number, function, operation, or component such as a part) indicate the existence of the feature and do not exclude the existence of other features. Also, as used here, the phrases “A or B,”, “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms may be used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), the element can be coupled or connected with/to the other element directly or via a third element. It will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially refer to “specifically designed in hardware to.” Rather, the phrase “configured to” may refer, for example, to a device being capable of performing an operation together with another device or parts. For example, the phrase “processor configured (or set) to perform A, B, and C” may refer to a generic-purpose processor (such as a CPU or application processor) that may perform the operations by executing one or more software programs stored in a memory device or a dedicated processor (such as an embedded processor) for performing the operations.

The terms and phrases as used here are provided merely to describe various example embodiments of this disclosure but not to limit the scope of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the disclosure belongs. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include, without limitation, at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, a wearable device (such as smart glasses, a head-mounted device (HMD), electronic clothes, an electronic bracelet, an electronic necklace, an electronic accessory, an electronic tattoo, a smart mirror, a smart watch), or the like. Other examples of the “electronic device” include a smart home appliance. Examples of the smart home appliance may include, without limitation, at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC), a smart speaker or speaker with an integrated digital assistant (such as SAMSUNG GALAXY HOME), a gaming console, an electronic dictionary, an electronic key, a camcorder, an electronic picture frame, or the like. Still further examples of the “electronic device” include, without limitation, at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, Internet of Things (IoT) devices (such as a bulb, various sensors, electric or gas meter, sprinkler, fire alarm, thermostat, street light, toaster, fitness equipment, hot water tank, heater, or boiler), or the like. Additional examples of the “electronic device” include at least one part of a piece of furniture or building/structure, an electronic board, an electronic signature receiving device, a projector, various measurement devices (such as devices for measuring water, electricity, gas, or electromagnetic waves), or the like. Note that, according to various embodiments of this disclosure, the “electronic device” may be one or a combination of the above-listed devices. According to various embodiments of this disclosure, the “electronic device” may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this disclosure. Those skilled in the art should understand that in many if not most instances, such definitions apply to prior as well as future uses of such defined words and phrases.

Throughout the present disclosure, expressions such as “at least one of a, b or c”, “at least one of a, b, or c”, “at least one of a, b and c”, “at least one of a, b, and c” may indicate “a,” “b,” “c,” “a and b,” “a and c,” “b and c,” “all of a, b, and c,” or variations thereof. Similarly, expressions such as “at least one of a or b”, “at least one of a, or b”, “at least one of a and b”, “at least one of a, and b” may indicate “a,” “b,”, “a and b,” or variations thereof.

In this disclosure, the expression “and/or” includes a combination of a plurality of described components or any component of the plurality of described components. In this disclosure, terms such as “1^{st},” “2^{nd},” “first,” and “second” may be merely used to distinguish a corresponding component from other corresponding components and do not limit the corresponding components in terms of other aspects (for example, the degree of importance or the order).

Throughout the present disclosure, when a part “includes” or “comprises” an element, the part may further include other elements, not excluding the other elements, unless there is a particular description contrary thereto.

The terms “portion,” “module,” etc. described in this disclosure denote a unit configured to process at least one function or operation, and the “portion,” and the “module” may be realized as hardware or software, such as a field programmable gate array (FPGA) or an application specific integrated circuit (ASIC), or a combination of the hardware and the software. The term “portion” used in an embodiment of the present disclosure does not have a meaning limited to software or hardware. A “portion” described in the present disclosure may be configured to be in a storage medium which may be addressed or may be configured to play one or more processors. According to an embodiment of the present disclosure, a “portion” may include components, such as software components, object-oriented software components, class components, and task components, processes, functions, attributes, procedures, sub-routines, segments of a program code, drivers, firmware, a microcode, a circuit, data, a database, data structures, tables, arrays, and variables. Functions provided through a predetermined component or a predetermined “portion” may be combined to reduce the number of functions or may be divided into additional components. Also, according to an embodiment, a “portion” may include one or more processors.

According to an embodiment of the present disclosure, each of blocks of the flowcharts and combinations of the flowcharts may be performed by computer program instructions. The computer program instructions may be loaded on a general-purpose computer, a specialized computer, or a processor of other programmable data processing device. The instructions performed through the computer or the processor of the other programmable data processing device may generate a medium for performing the functions described in the flowchart block(s). The computer program instructions may also be stored in a computer-available or computer-readable memory oriented for the computer or the other programmable data processing device in order to realize the functions in a predetermined way. The instructions stored in the computer-available or computer-readable memory may also produce manufacturing items embedding an instruction medium for performing the functions described in the flowchart block(s). The computer program instructions may also be loaded on the computer or the other programmable data processing device.

Each block in the flowcharts may represent a module, segment, or a part of code including one or more executable instructions to perform particular logic function(s). According to an embodiment of the present disclosure, the functions described with respect to the blocks may also be generated not according to an order. For example, two blocks illustrated in succession may be executed substantially concurrently or the blocks may sometimes be executed in a reverse order, depending on the functions involved therein.

Hereinafter, various example embodiments of the present disclosure will be described in greater detail with reference to the accompanying drawings. However, the example embodiments of the present disclosure may have different forms and should not be construed as being limited to the various example embodiments of the present disclosure described herein. In the drawings, parts not related to descriptions may be omitted for the clear description, and throughout the disclosure, like reference numerals are used for like elements.

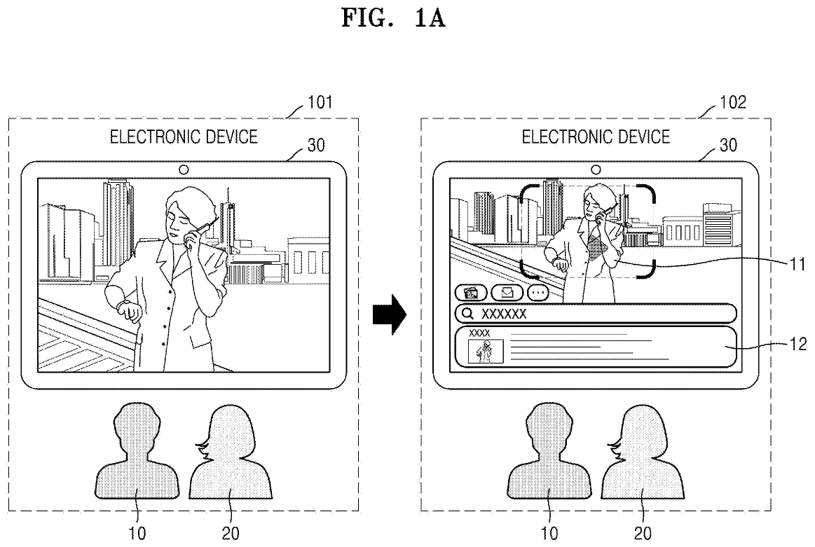

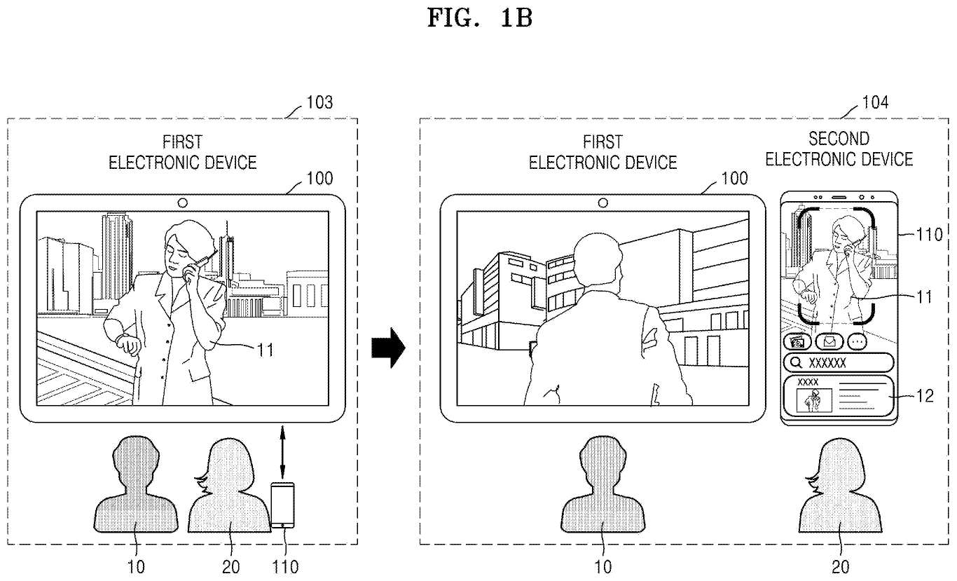

FIG. 1A is a diagram illustrating an example of displaying a search result related to various example embodiments. FIG. 1A illustrates an example of multiple users watching a video (e.g., a movie) together at home.

At 101 in FIG. 1A, a first user 10 and a second user 20 are watching a video together on an electronic device 30 (e.g., a tablet computer). While watching the video, an image of beautiful and unique clothing appears on the screen, and the second user 20 is immediately attracted by the clothing. The second user 20 becomes interested in knowing the brand and style of the clothing, where the clothing can be purchased, and how the clothing might look when worn. The first user 10, who is more interested in the plot of the movie, is not particularly drawn to this style of the clothing and prefers to continue watching the movie.

At 102 in FIG. 1A, the first user 10 usually waits for the second user 20 to activate a function of the electronic device 30 to directly select and search for the new style of clothing shown in the video. For example, when the second user 20 searches for the new style of clothing via the electronic device 30, the electronic device 30 may pause the current video and display a search screen, which directly affects the video watching experience of the first user 10. The search screen may be a screen to display interface information (or an interface) of a search application, such as Circle to Search application. The search screen may include a target object 11 and view information 12 related to the target object 11 (including but not limited to shopping, navigation, encyclopedias, etc.).

In the case of FIG. 1A, the first user 10 is not interested in the style of the clothing shown in the video, but may have to wait until the second user 20 finishes searching for the clothing or the second user 20 may have to suppress his/her curiosity and continue watching the video with the first user 10. As a result, a time of the first user 10 may be wasted or the curiosity of the second user 20 may remain unsatisfied.

FIG. 1B is a diagram illustrating an example of displaying a search result according to various example embodiments. FIG. 1B illustrates an example of multiple users watching a video together at home.

At 103 in FIG. 1B, the first user 10 and the second user 20 are watching the video together on a first electronic device 100 (e.g., a tablet computer). While watching the video, a scene displaying unique and stylish clothing appears, which immediately attracts the attention of the second user 20. The second user 20 becomes interested in identifying the brand and style of the clothing, where the clothing can be purchased, and how the clothing might look when worn. The first user 10, who is focused on the videos plot, is less interested in the outfit and prefers to continue watching the movie.

At 103 in FIG. 1B, upon receiving an input from the second user 20, the first electronic device 100 may activate a search function and then select the target object 11 on the screen. For example, the input from the second user 20 may include a user-triggered search operation. For example, the user-triggered search operation may include a long press on a home button of the first device 100 to start a search application. For example, the user-triggered search operation may include a long press on the home button of the first device 100 to trigger a search function. For example, the input from the second user 20 may include a long press input on the home button of the first device 100 to start the search application. For example, the input from the second user 20 may include a long press input on the home button of the first device 100 to trigger the search function. The input is not limited to these examples. To discover nearby devices, the first electronic device 100 may broadcast a packet using a protocol such as a User Datagram Protocol (UDP). When the second electronic device 110 responds to the broadcasted packet, the first electronic device 100 may establish a connection with the second electronic device 110. The first electronic device 100 may search for the second electronic device 110 by scanning for UDP broadcasts, and then establish a socket connection with the searched second electronic device 110. The second electronic device 110 may connected to the same wireless communication network as the first electronic device 100.

In 104 of FIG. 1B, the first electronic device 100 may create a virtual screen based on the current screen. The virtual screen may be used to display interface information (or an interface) of a search application, such as Circle to Search application. The virtual screen may correspond to the search screen shown in FIG. 1A. The first electronic device 100 may encode the virtual screen into a video stream, and transmit the encoded video stream to the second electronic device 110 for displaying the virtual screen. The second electronic device 110 may then decode the received video stream and display the decoded video stream on a screen of the second electronic device 110. 104 of FIG. 1B may enable the second user 20 to perform desired searches via the virtual screen on the second electronic device 110, while the first user 10 may continue watching on the first electronic device 100 without interruption from the search of the second user 20. The virtual screen may be a screen to display interface information (or an interface) of a search application, such as Circle to Search application. The search screen may include the target object 11 and the view information 12 related to the search object 11 (including but not limited to shopping, navigation, encyclopedias, etc.). The view information 12 may be included in a search result or may be referred to as the search result.

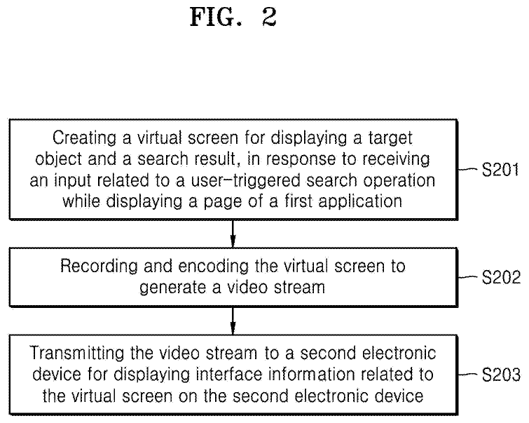

FIG. 2 is a flowchart illustrating an example method of displaying a search result, as performed by the first electronic device 100 according to various embodiments. In this example, the method for displaying the search result may be executed by an application installed on the first electronic device 100 that supports the circle-to-search function. In the present disclosure, the search function or the circle-to-search function is not limited to the functionality of a particular application, but may include the functionality of any application that supports the search function or the circle-to-search function. In the present disclosure, the application that supports the circle-to-search function is used as an example.

Referring to FIG. 2, in operation S201, in response to receiving a search operation (e.g., a user-triggered search operation) while displaying a page of a first application, the first electronic device 100 may create a virtual screen for displaying a target object and a search result (or view information) related to the target object 11. The user-triggered search operation may be referred to as a search input requesting a search for a target object. The virtual screen may be used to display the interface information of the search application, such as Circle to Search application. The virtual screen may be created by the search application installed on the first electronic device 100, but is not limited to these. The page of the first application may include an image or a video, but is not limited to these. The user-triggered search operation may be an operation for selecting a target object 11 in the page of the first application. The first electronic device 100 may activate a search function (e.g., but is not limited to, a circle-to-search function in video, a circle-to-search function in image, a long-press to search, etc.), and the circle-to-search function may allow the user to select the target object 11 in the page by circling the page with a circle drawn by the hand. Based on the circle-to-search function, the user can select the target object 11 (or target content) by drawing a circle or clicking on the target object 11 with a finger anywhere on the page (or a screen of the first electronic device 100), and search and view information related to the target object 11 (which may include, for example, but is not limited to, shopping, navigation, Wikipedia, etc.). The first application may include a streaming service application, but is not limited to these. The first application may be referred to as an application.

In an embodiment of the present disclosure, the first electronic device 100 may connect to the second electronic device 200, in response to receiving an input related to the user-triggered search operation while displaying the page of the first application, thereby facilitating data transmission between the first electronic device 100 and the second electronic device 200. The input related to the user-triggered search operation may include a user-triggered search operation. For example, the user-triggered search operation may include a long press on a home button of the first device 100 to start a search application. For example, the user-triggered search operation may include a long press on the home button of the first device 100 to trigger a search function. For example, the input related to the user-triggered search operation may include a long press input on the home button of the first device 100 to start the search application. For example, the input related to the user-triggered search operation may include a long press input on the home button of the first device 100 to trigger the search function. The input is not limited to these examples. The second electronic device 200 may be connected to the same wireless communication network as the first electronic device 100. For example, the wireless communication network may be, for example, but is not limited to, 4G, 5G, 6G, ZigBee, wireless local area network (WLAN), Wi-Fi, Bluetooth, and the like.

In an embodiment of the present disclosure, to connect to the second electronic device 110, the first electronic device 100 may search for the second electronic device 110 by scanning for user datagram protocol (UDP) broadcasts, and establish a socket connection with the searched second electronic device 110, thereby allowing two programs to communicate over the network on different devices (the first electronic device 100 and the second electronic device 110) and increasing the data transmission rate. For example, the first electronic device 100 firstly may search for a user datagram protocol broadcast and then connect to the second electronic device 110 under a same Wi-Fi.

The User Datagram Protocol (UDP) refers to a connectionless simple datagram-oriented transport layer protocol. Since the UDP does not require establishing a connection (e.g., 3-way handshake in TCP (Transmission Control Protocol)) between the client and the server before transmitting a datagram, and because there are no mechanisms such as timeout retransmissions, the transmission rate is high. As the UDP does not require a connection for communication, broadcasting is possible.

The socket connection refers to a communication mechanism in a computer network that allows two programs on different computers (e.g., the first electronic device 100 and the second electronic device 110) to communicate over the network. When using the UDP for socket connection, one program acts as a client and the other program acts as a server, and data can be transmitted by creating and using the socket connection without establishing a persistent connection.

In an embodiment, while the first electronic device 100 is playing a video, the second user 20 may long-press the home key to start the circle-to-search function. In response to receiving an input based on the long-press of the home key by the second user 20, the first electronic device 100 may pause the video play, and then may take a screenshot of the interface information of the first electronic device 100. Taking the screenshot of the interface information of the first electronic device 100 may represent capturing the interface information of the first electronic device 100. The interface information may be a screen (or a current screen or a current video) displayed on the first electronic device 100 when the video play is paused on the first electronic device 100. The first electronic device 100 may store the screenshot of the interface information. The circle-to-search function application of the first electronic device 100 may acquire the screenshot of the interface information and then obtain the target object 11 circled by the second user 20. The target object 11 may be at least one object include in the screenshot. The screenshot may include the search screen. The screenshot may include the target object 11 and a search result 12 (or view information or a search result) related to the target object 11.

For example, the circle-to-search function application of the first electronic device 100 may start scanning the user datagram protocol broadcast to search for the second electronic device 110 after it is detected that the second user 20 is circling or clicking on the target object 11. After the second electronic device 110 is found, the first electronic device 100 may establish a wireless socket connection between the first electronic device 100 and the second electronic device 110. For example, the first electronic device 100 and the second electronic device 110 may be on the same WiFi network or Bluetooth network.

In an embodiment of the present disclosure, the first electronic device 100 may create a virtual screen for displaying the target object and the search result. For example, after the first electronic device 100 establishes the wireless socket connection with the second electronic device 110, the first electronic device 100 may receive a user's acceptance of screen projection (or a screenshot or a screen cast) on the second electronic device 110. The user's acceptance of screen projection may indicate that the second user 20 is willing to accept the screen projection or the screen cast on the second electronic device 110. The second electronic device 110 may transmit the user's acceptance of screen projection on the second electronic device 110 to the first electronic device 100, in response to receiving an input (or a click) confirming that the second user 20 is willing to accept the screen projection feature (or a screen cast) via the second electronic device 110. The screen projection feature allows the screen of the first electronic device 100 (or one device) to be displayed on or transmitted to the second electronic device 110 (or another device). The screen projection feature may include functionalities such as screenshot, screen mirroring, screen casting, or a mirroring. The user's acceptance of screen projection may be referred to as feedback from the second electronic device 110 confirming acceptance of screen cast. The screen cast may be referred to as a screen transmission feature that may refer to a technology that transmits or records the content displayed on the screen of a device to another screen or another device. After receiving the user's acceptance of screen projection, the first electronic device 100 may create the virtual screen for displaying the target object and the search result. For example, the second user 20 may click on the second electronic device 110 to confirm willingness to accept the screen cast, indicating that the second user 20 agrees to enable the searching while playing the video on the first electronic device 100. In an embodiment of the present disclosure, both the first electronic device 100 and the second electronic device 110 have a screen casting function, e.g., a screen casting application is installed thereon. The second electronic device 110 may be a device unrelated to the second user 20 (e.g., a device not owned by the second user 20). The second electronic device 110 may be a device related to the second user 20 (e.g., a device owned or used by the second user 20). The second electronic device 110 may be a device through which the second user 20 can search for information. The second electronic device 110 may be a device located near a location of the second user 20. The second electronic device 110 may be a device through which the second user 20 may input data (e.g., data confirming acceptance for the screen cast). If the second user 20 is referred to as the subject entering the search input, the second electronic device 110 may be a device controlled by the subject entering the search input. The second electronic device (110) may include a device controlled by the second user 20 who entered the search input. The second electronic device 110 may include at least one of the examples of the “electronic device” according to embodiments of this disclosure. The first electronic device 100 may include at least one of the examples of the “electronic device” according to embodiments of this disclosure.

In an embodiment, the first electronic device 100 may display two screens simultaneously. A first screen (Screen 1, or a main screen) is used to continue playing the previous video. At this time, on the first electronic device 100, the first user 10 and the second user 20 can see the video content of first screen (not including the search result). A second screen (Screen 2, or the virtual screen) is used for the circle-to-search application to search for video function logic and to display. For example, the video function logic may include the process of searching for related video functions or data to find the desired video content (or the view information) when the user is using the circle-to-search application. The video function logic may refer to exploring the necessary logic or algorithms to efficiently find or manipulate video content.

In an embodiment of the present disclosure, the method for displaying the search result by a first electronic device 100 may include pausing the play of the first application by the first electronic device 100, in response to receiving an input related to the user-triggered search operation while displaying the page of the first application. The method may include resuming the play of the first application by the first electronic device 100, in response to receiving feedback from the second electronic device 110 of determining acceptance for the screen cast. The first application may include, for example, but is not limited to, at least one of a video application, a slideshow application, or a picture application.

In operation S202, the first electronic device 100 may record and encode the virtual screen to generate a video stream.

In operation S203, the first electronic device 100 may transmit the video stream to the second electronic device 110, for displaying on the second electronic device.

Herein, the first electronic device 100 may transmit the video stream to the second electronic device 110 via a transmitting method such as wireless transmission, however the present disclosure is not limited thereto.

As an example, in response to acceptance for the screen cast is confirmed by the second user 20 on the second electronic device 110, the first electronic device 100 may create a virtual screen for displaying the interface information of the circle-to-search in the operation S201 (e.g., via a circle-to-search application on the first electronic device 100), encode the virtual screen in the operation S202. The first electronic device 100 may transmit the encoded virtual screen to the second electronic device 110 by means of the screen cast in the operation S203, thus transmit the search result to the second electronic device 110. Transmitting the search result to the second electronic device 110 may be referred to as sending the search result to the second electronic device 110.

In an example embodiment of the present disclosure, the method for displaying the search result may include responding, by the virtual screen of the first electronic device 100, to the operation, based on the receiving of an operation of the second user 20 with respect to a video stream display interface from the second electronic device 110, thus enabling inverse control of the virtual screen without affecting the play of the application.

In an embodiment, while multiple users (e.g., the first user 10 and the second user 20) are watching a video on the first electronic device 100 together, when one (e.g., the second user 20) of the users wants to search for relevant content (or a target object) in the video, the first electronic device 100 may trigger the search for the relevant content (or the target object 11) through the circle-to-search function. The first electronic device 100 and the second electronic device 110 under the same Wi-Fi network may establish a wireless connection, and the search result on the first electronic device 100 is displayed by a virtual screen recording and casting the search result on the first electronic device to the second electronic device 110, and the first electronic device 100 is inversely controlled by the second electronic device 110, then the second user 20 continues to search and view, while the other users (e.g., the first user 10) can continue to watch the video on the first electronic device 100.

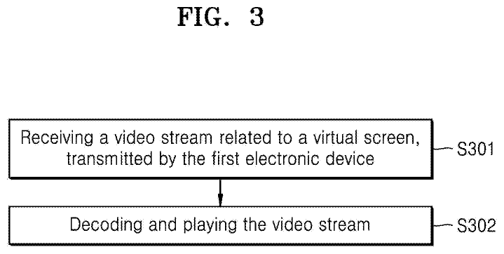

FIG. 3 is a flowchart illustrating an example method of displaying a search result as performed by a second electronic device 110 according to various example embodiments.

Referring to FIG. 3, in operation S301, a video stream related to a virtual screen sent by the first electronic device is received.

In an embodiment of the present disclosure, a socket connection may be established between the second electronic device 110 and the first electronic device 100, thus facilitating data transmission.

In an embodiment of the present disclosure, after establishing the socket connection, the second electronic device 110 may receive the video stream related to the virtual screen transmitted by the first electronic device 100 by a casting application, thus not affecting the continued play of the first electronic device 100.

In operation S302, the second electronic device 110 may decode and display the video stream.

After the second electronic device 110 may receive the video stream related to the virtual screen (e.g., the virtual screen information) in the operation S301, the second electronic device 110 may start to decode the video stream in the operation S302, and after decoding, the second electronic device 110 may play and display the decoded cast screen content (e.g., the virtual screen) on the second electronic device 110 so that the second user 20 can view the search result of the circle-to-search on the second electronic device 110.

In an embodiment of the present disclosure, the method for displaying the search result shown in FIG. 3 may include that the second electronic device 110 may receive an operation (or an input based on an operation) of the second user 20 (or a user) with respect to the video stream display interface and transmit the operation to the first electronic device 100; and receive and update video stream data for displaying the result of the virtual screen of the first electronic device 100 responding to the operation, so that inverse control of the virtual screen is enabled.

In an embodiment, the second user 20 may be allowed to inversely control the circle-to-search function application on the second electronic device 110. For example, the second user 20 may click on the second electronic device 110 to view the search detail and may go straight to the search result.

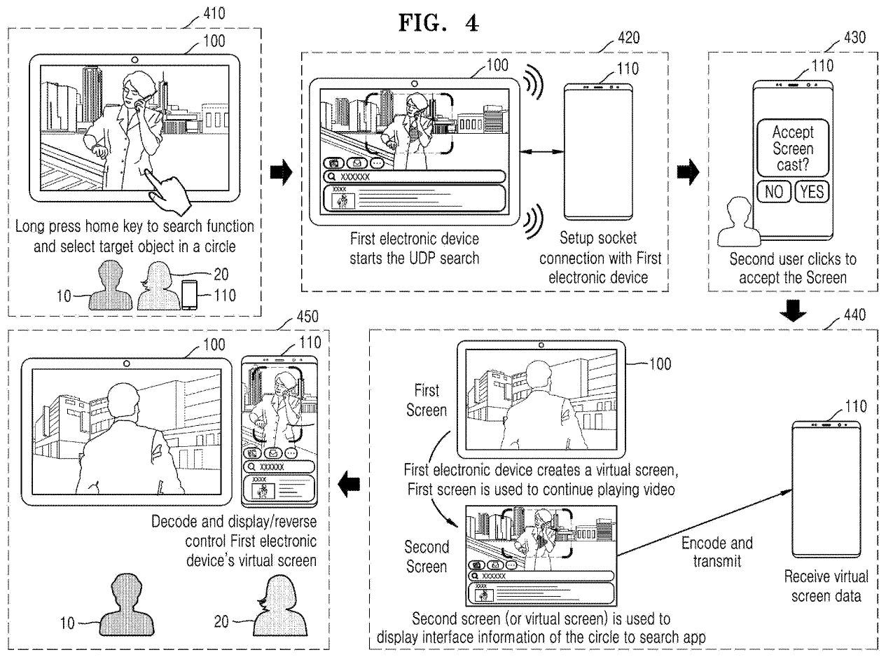

FIG. 4 is a diagram illustrating an example of displaying of a search result of a search performed by the first electronic device 100 and the second electronic device 110 according to various example embodiments.

In 410 of FIG. 4, the first user 10 and the second user 20 watch a video (e.g., a movie) on the first electronic device 100 (e.g., a tablet computer) together. A picture of beautiful and novel style of clothing appears on the screen of the first electronic device 100, and the second user 20 is attracted by the clothing and wants to know what brand and what style of the clothing is, where to buy the clothing, and whether the clothing is as beautiful as in the video when the second user 20 wears the clothing. Due, for example, to personal preference, the first user 10 is not really interested in this kind of clothing, but is more interested in the plot of the video, and the first user 10 wants to continue watching the video. When the second user 20 long-presses the home button on the first electronic device 100 to start the circle-to-search function, the first electronic device 100 may pause the play of the video. The first electronic device 100 may select a target object 11 from the paused video screen based on a selection input of the second user 20. The selection input may include circling or clicking on the target object in the paused video screen with her hand. In response to receiving the selection input, the first electronic device 100 may capture a screenshot of the clothing displayed on the paused video screen, and then may use the circle-to-search function application (e.g., the circle-to-search app in FIG. 4) to identify the clothing selected by the second user 20 as the target object.

At 420, the first electronic device 100 may establish a communication connection with the second electronic device 110. For example, the first electronic device 100 may initiate a user datagram protocol search, search for the second electronic device 110 of the second user 20, and establish a socket connection with the searched second electronic device 110.

At 430, the first electronic device 100 may request for the socket connection to the second electronic device 110 by transmitting the message “Accept screen cast?” to the second electronic device 110. When the second user 20 clicks to confirm the acceptance for the screen cast, at 440, the first electronic device 100 may create a virtual screen to search for the target object on the screen, including the clothing selected by the second user 20. the first electronic device 100 has two screens running at the same time. A first screen (screen 1 or main screen) is used to continue the playing of the previous video. A second screen (screen 2 or a virtual screen) is used for the circle-to-search application to search for the video function logic and to display. The first user 10 and the second user 20 will see the video content of the first screen (not including the search result) via the first electronic device 100.

At 450, the first electronic device 100 may encode the created virtual screen and transmit the encoded virtual screen data to the second electronic device 110. The second electronic device 110 receives the virtual screen data. After the virtual screen data is received, the second electronic device 110 may decode the virtual screen data to obtain a virtual screen, and display the obtained virtual screen. The second user 20 may perform the inverse control to the virtual screen on the second electronic device 110. The first electronic device 100 may obtain an operation virtual screen according to the inverse control operation, and transmit the operation virtual screen including the result of the inverse control operation to the second electronic device 110 for displaying the operation virtual screen on the second electronic device 110, thereby realizing the inverse control of the virtual screen.

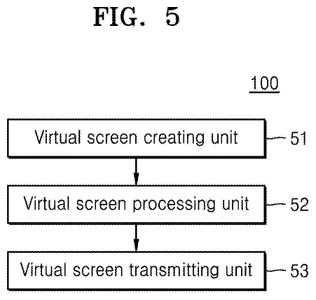

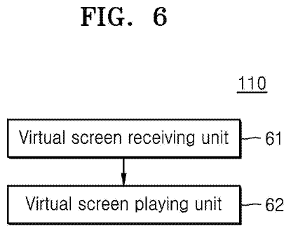

The method for displaying a search result according to an example embodiment of the present disclosure has been described above in conjunction with FIG. 1A~FIG. 4. The device for displaying a search result according to an example embodiment of the present disclosure will be described in greater detail below with reference to FIG. 5 and FIG. 6.

FIG. 5 is a block diagram illustrating an example configuration of a first electronic device 100 for displaying a search result according to various example embodiments.

Referring to FIG. 5, the first electronic device 100 for displaying the search result includes a virtual screen creating unit (e.g., including various circuitry and/or executable program instructions) 51, a virtual screen processing unit (e.g., including various circuitry and/or executable program instructions) 52, and a virtual screen transmitting unit (e.g., including various circuitry and/or executable program instructions) 53, but the configuration of the first electronic device 100 is not limited thereto.

The virtual screen creating unit 51 may include various circuitry and/or executable program instructions and is configured to create a virtual screen for displaying a target object and a search result, in response to receiving a user-triggered search operation while displaying a page of a first application.

In an embodiment of the present disclosure, the first electronic device 100 for displaying the search result may include a connecting unit (not shown) configured to connect to the second electronic device 110, in response to receiving the user-triggered search operation while displaying the page of the first application. The second electronic device 110 is connected to the same wireless communication network, such as a Wifi network or a Bluetooth network, as the first electronic device 100.

In an embodiment of the present disclosure, the connecting unit may include various circuitry and/or executable program instructions and may be configured to search for the second electronic device 110 by scanning for user datagram protocol (UDP) broadcasts, and to establish a socket connection with the searched second electronic device 120.

In an embodiment of the present disclosure, the first electronic device 100 for displaying the search result may include a displaying controlling unit configured to pause the play of the first application in response to receiving the user-triggered search operation while displaying the page of the first application, and to resume the play of the first application in response to receiving feedback from the second electronic device 110 of determining acceptance for screen cast.

The virtual screen processing unit 52 is configured to record and encode the virtual screen to generate a video stream.

In an embodiment of the present disclosure, the virtual screen creating unit 52 may be configured to request for the screen cast to the second electronic device 110, and to create the virtual screen for displaying the target object and the search result, in response to receiving feedback from the second electronic device 110 of determining acceptance for the screen cast.

The virtual screen transmitting unit 53 is configured to transmit the video stream to a second electronic device 110 for displaying on the second electronic device 110.

In an embodiment of the present disclosure, the first electronic device 100 for displaying the search result may include an inverse controlling unit (not shown) configured to respond, by the virtual screen of the first electronic device 100, to the operation, based on the receiving of an operation of the user with respect to the video stream display interface from the second electronic device 110.

FIG. 6 is a block diagram illustrating an example configuration of a second electronic device 110 for displaying a search result according to various example embodiments.

Referring to FIG. 6, the second electronic device 110 for displaying the search result includes a video stream receiving unit (e.g., including various circuitry and/or executable program instructions) 61 and a video stream playing unit (e.g., including various circuitry and/or executable program instructions) 62, but a configuration of the second electronic device 110 is not limited thereto.

The video stream receiving unit 61 is configured to receive a video stream related to a virtual screen, which is transmitted by the first electronic device 100.

In an embodiment of the present disclosure, before receiving the video stream, the second electronic device 110 may establish a socket connection with the first electronic device 100. To establish the socket connection, the second electronic device 110 may include a connection unit (not shown) that may include various circuitry and/or executable program instructions configured to connect with the first electronic device 110, after transmitting feedback from the second electronic device 110 confirming acceptance of the screen cast to the first electronic device 100.

In an embodiment of the present disclosure, the video stream receiving unit 61 may be configured to receive the video stream related to the virtual screen which is sent by the first electronic device 100 through a casting application (or a screen projection application).

The video stream playing unit 62 is configured to decode and play the video stream.

In an embodiment of the present disclosure, the second electronic device 110 for displaying the search result may include an inverse controlling unit (not shown) including various circuitry and/or executable program instructions configured to receive an operation of a user with respect to the video stream display interface, to transmit the operation to the first electronic device 100, and to receive and update video stream data for displaying a result of the virtual screen of the first electronic device 100 responding to the operation.

According to an embodiment of the present disclosure, there is also provided a non-transitory computer-readable storage medium having a computer program stored thereon, and when the computer program is executed, a method for displaying a search result according to the various example embodiments of the present disclosure is implemented.

In an embodiment of the present disclosure, the computer-readable storage medium may carry one or more programs that, when executed, may implement the operations of creating a virtual screen for displaying a target object and a search result, in response to receiving a user-triggered search operation while displaying a page of a first application; recording and encoding the virtual screen to generate a video stream, and transmitting the video stream to the second electronic device 110 for displaying on the second electronic device, and thus the search result display in a manner of searching while playing is realized at the first electronic device 100.

In an embodiment of the present disclosure, the non-transitory computer-readable storage medium may carry one or more programs that, when executed, may implement the operations of receiving a video stream related to the virtual screen, which is transmit by the first electronic device 100, and decoding and playing the video stream, and thus the search result display in a manner of searching while playing is realized at the second electronic device 120.

The non-transitory computer-readable storage medium can be, for example, but not limited to, an electrical, magnetic, optical, electromagnetic, infrared, or semiconductor system, apparatus or device, or any combination of the above. Examples of computer-readable storage medium may include, but are not limited to, electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In an embodiment of the present disclosure, a computer-readable storage medium may be any tangible medium that contains or stores a computer program that can be used by or in conjunction with an instruction execution system, apparatus, or device. The computer program contained on the computer-readable storage medium may be transmitted using any appropriate medium, including but not limited to: wire, fiber optic cable, RF (radio frequency), etc., or any suitable combination of the above. The computer-readable storage medium may be included in any device, or it may also exist as a standalone medium without being incorporated into the device.

According to an embodiment of the present disclosure, there is also provided a computer program product, wherein instructions in the computer program product can be executed by a processor of the computer device to implement the method for displaying a search result according to the example embodiments of the present disclosure.

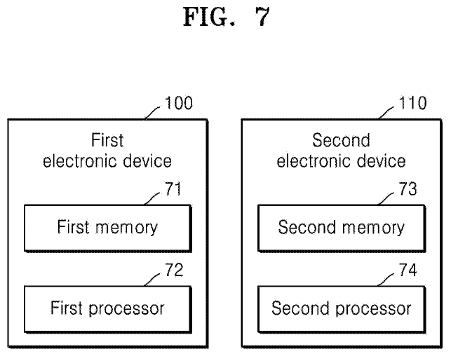

The device for displaying a search result according to an embodiment of the present disclosure has been described above in conjunction with FIG. 5 and FIG. 6. A computing device according to an example embodiment of the present disclosure will be described in greater detail below with reference to FIG. 7.

FIG. 7 is a block diagram illustrating example configurations of the first electronic device 100 and the second electronic device 110 according to various example embodiments. The first electronic device 100 may be referred to as a first computing device. The second electronic device 110 may be referred to as a second computing device.

Referring to FIG. 7, the first electronic device 100 may include a first memory 71 and a first processor (e.g., including processing circuitry) 72. The first memory 71 stores at least one computer program or at least one instruction. When the at least one computer program (or the at least one instruction) stored in the first memory 71 is executed by the first processor 72, the first electronic device 100 may perform a method for displaying a search result, according to an embodiment of the present disclosure. The first memory 71 may be referred to as at least one first memory. The first processor 72 may be referred to as at least one first processor. When it is described that the first processor 72 performs various operations, it includes the first processor 72 causing an electronic device to perform various operations.

In an embodiment of the present disclosure, when the computer program stored in the first memory 71 is executed by the first processor 72, the first processor 72 may create a virtual screen for displaying a target object and a search result, in response to receiving a search input, such as a user-triggered search operation, while displaying a page of a first application, encode the virtual screen to generate a video stream, and transmit the video stream to the second electronic device 110, for displaying on the second electronic device 110, and thus the search result display in a manner of searching while playing is realized at the first electronic device 100. The first processor 72 may record the virtual screen to the first memory 71. The first processor 72 may include the virtual screen creating unit 51, the virtual screen processing unit 52, and the virtual screen transmitting unit 53, as shown in FIG. 5. The first processor 72 may perform the operations of the virtual screen creating unit 51, the virtual screen processing unit 52, and the virtual screen transmitting unit 53 shown in FIG. 5.

In an embodiment of the present disclosure, the first processor 72 may pause the play of the application, in response to receiving the search input while displaying the page of the application, and resume the play of the application in response to receiving feedback from the second electronic device 110 confirming acceptance for the screen cast.

In an embodiment of the present disclosure, the first processor 72 may request for screen cast to the second electronic device 110, and create the virtual screen for displaying the search object and the search result in response to receiving feedback from the second electronic device 110 confirming acceptance for the screen cast.

In an embodiment of the present disclosure, the first processor 72 may control a search function application installed in the first electronic device 100 in response to a user input received from the second electronic device 110 via interface information related to the virtual screen, wherein the virtual screen has been created by the search function application in the first electronic device (100).

Referring to FIG. 7, the second electronic device 100 may include a second memory 73 and a second processor (e.g., including processing circuitry) 74. The second memory 73 stores at least one computer program or at least one instruction. When the at least one computer program (or the at least one instruction) stored in the second memory 73 is executed by the second processor 74, the second electronic device 110 may perform a method for displaying a search result according to an embodiment of the present disclosure. The second memory 73 may be referred to as at least one second memory. The second processor 74 may be referred to as at least one second processor. When it is described that the second processor 74 performs various operations, it includes the second processor 74 causing an electronic device to perform various operations.

In various example embodiments of the present disclosure, when the computer program stored in the second memory 73 is executed by the second processor 74, the second processor 74 may receive a video stream related to the virtual screen, which is transmitted by the first electronic device 100, decode the video stream, and play the decoded video stream on the second electronic device (110). Thus, the search result display in a manner of searching while playing is realized at the second electronic device 110. The second processor 74 may include the video stream receiving unit 61 and video stream playing unit 62, as shown in FIG. 6. The second processor 74 may perform an operation of the video stream receiving unit 61 and video stream playing unit 62 shown in FIG. 6. The second processor 74 may display, on the second electronic device (110), interface information related to the virtual screen, in response to playing the decoded video stream, wherein the interface information includes a target object and a search result. The second processor 74 may receive a user input via the interface information related to the virtual screen. The second processor 74 may transmit the user input to the first electronic device (100). The second processor 74 may receive another video stream acquired according to the user input from the first electronic device (100), and update the interface information related to the virtual screen using the received video stream.

The first electronic device 100 and the second electronic device 110 in an embodiment of the present disclosure may include, but are not limited to, devices such as mobile phones, notebook computers, PDAs (personal digital assistants), PADs (tablet computers), desktop computers, and the like. The first electronic device 100 and the second electronic device 110 shown in FIG. 7 are only examples, and should not impose any limitation on the function and scope of use of the present disclosure. The first electronic device 100 and the second electronic device 110 may each include a communication interface for discovering UDP broadcast and transmitting a packet based on the UDP. The first electronic device 100 and the second electronic device 110 may establish a wireless socket connection via the communication interface.

The first memory 71 may be communicatively coupled to the first processor 72. The second memory 73 may be communicatively coupled to the second processor 74. The first memory 71 and the second memory 73 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. For example, the first memory 71 may include a cache or random-access memory for the first processor 72. the second memory 73 may include a cache or random-access memory for the second processor 74. For example, the first memory 71 is separate from the first processor 72, such as a cache memory of a processor, the system memory, or other memory. The first memory 71 may be an external storage device or database for storing data. The first memory 71 may be operable to store instructions (or computer programs) executable by the first processor 72. The second memory 73 is separate from the second processor 72, such as a cache memory of a processor, the system memory, or other memory. The second memory 73 may be an external storage device or database for storing data. The second memory 73 may be operable to store instructions (or computer programs) executable by the second processor 74.

The first processor 72 and the second processor 74 may each include a central processing unit (CPU), a graphics processing unit (GPU), or both. The first processor 72 and the second processor 74 may each be one or more general processors, digital signal processors, application-specific integrated circuits, field-programmable gate arrays, servers, networks, digital circuits, analog circuits, combinations thereof, or other now known or later developed devices for analyzing and processing data. The fist processor 72 and the second processor 74 may each execute a software program, such as code to perform an operation for display search result according to the disclosure. Thus, the first and second processors 72 and 74 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The method and device for displaying a search result according to an embodiment of the present disclosure have been described above with reference to FIG. 1-FIG. 7. However, it should be understood that the device for displaying the search result and the units thereof shown in FIG. 5-FIG. 6 may be respectively configured with software, hardware, firmware or any combination of the above to perform specific functions, and the first electronic device 100 and the second electronic device 110 shown in FIG. 7 are not limited to include the above shown components, but some components may be added or deleted according to needs, and the above components may also be combined.

The method and device for displaying the search result according to an embodiment of the present disclosure may realize the display of the search result in a manner of searching while playing at the first electronic device 100, by creating a virtual screen for displaying a target object and a search result by the first electronic device 100, in response to receiving a search input (e.g., a user-triggered search operation) while displaying a page of a first application (an application), recording and encoding the virtual screen to generate a video stream, and sending the video stream to a second electronic device 110 for displaying on the second electronic device 110, thus.

The method and device for displaying the search result according to an embodiment of the present disclosure may realize the display of the search result in a manner of searching while playing at the second electronic device 110, by receiving, by the first electronic device 100, a video stream relate to the virtual screen transmitted by the first electronic device 100, and decoding and playing the video stream.

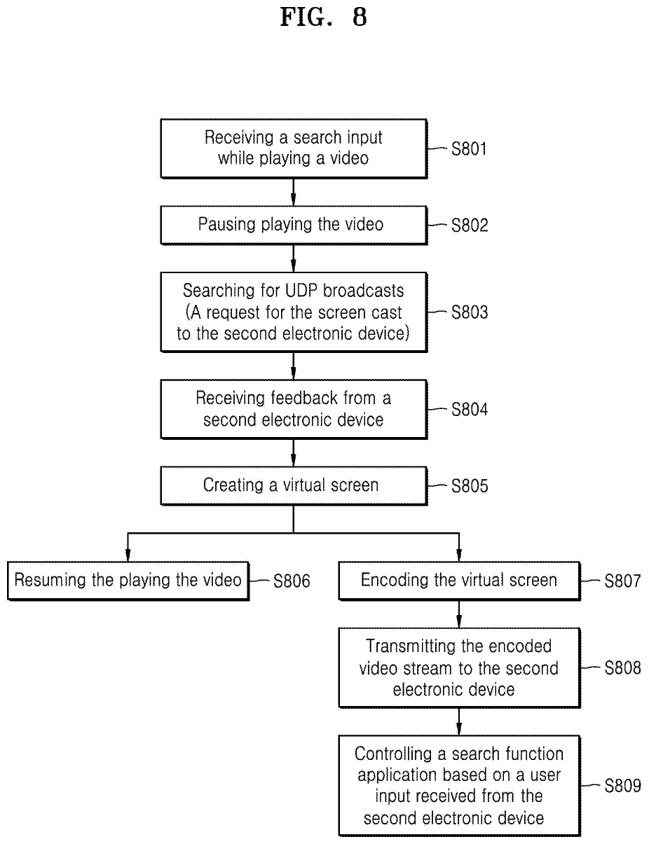

FIG. 8 is a flowchart illustrating an example method of displaying a search result as performed by a first electronic device 100 according to various example embodiments.

At step S801, the first electronic device 100 may receive a search input while displaying a page of an application on the first electronic device 100. If the application is a streaming application, the displaying a page of an application may be referred to as playing a video. The application is not limited to being the streaming application. The search input may include the search input described in FIG. 1B. For example, the search input may include a user-triggered search operation, or a long-press of the home key, etc.

At step S802, the first electronic device 100 may pause the play of the application (or playing the video), in response to receiving the search input. At step S803, the first electronic device 100 may search for UDP broadcasts. The search for UDP broadcasts may include a request for the screen cast to the second electronic device 110.

At step S804, the first electronic device 100 may receive feedback from the second electronic device 110. The feedback may include the second electronic device 110 confirming acceptance of the screen cast.

At step S805, the first electronic device 100 may create a virtual screen for displaying a target object and a search result, in response to receiving the feedback, but is not limited thereto. For example, the first electronic device 100 may create a virtual screen for displaying a target object and a search result in response to receiving the search input. In an embodiment of the disclosure, the operation of creating the virtual screen may include Steps S803, S804, and S805. The operation of creating the virtual screen may include a request for the screen cast to the second electronic device 110. In an embodiment, the first electronic device 100 may launch the search function application in response to receiving the feedback from the second electronic device 110, select the target object on the paused screen by circling of the second user 20 and create the virtual screen with the target object 11 marked, as shown in FIG. 1B. The first electronic device may create the virtual screen using the search application, such as Circle to Search application.

At step S806, while the first electronic device 100 may resume the play of the application, in response to receiving the feedback from the second electronic device 110 confirming acceptance for screen cast, the first electronic device 100 may also perform operations at step S807 to S809.

At step S807, the first electronic device 100 may encode the virtual screen to generate a video stream. The first electronic device 100 may record the virtual screen. At step S808, the first electronic device 100 may transmit the video stream to a second electronic device 110 for displaying interface information related to the virtual screen on the second electronic device 110. At step S809, the first electronic device 100 may control (or reverse control) the search function application installed in the first electronic device 100 in response to a user input received from the second electronic device 110 via interface information related to the virtual screen, wherein the virtual screen has been created by the search function application in the first electronic device 100. The method of FIG. 8 may be performed by the first processor 72 of the first electronic device 100.

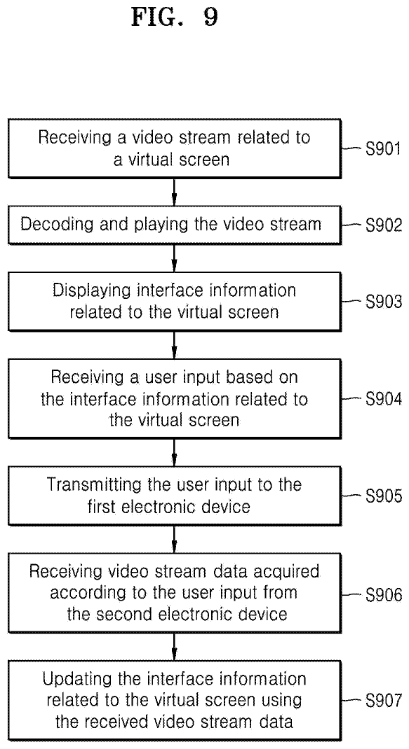

FIG. 9 is a flowchart illustrating an example method of displaying a search result as performed by a second electronic device 110 according to various example embodiments.

At step S901, the second electronic device 110 may receive a video stream related to a virtual screen from a first electronic device 100. At step S902, the second electronic device 110 may decode the received video stream and play the decoded video stream on the second electronic device 110.

At step S903, the second electronic device 110 may display on the second electronic device (110), interface information related to the virtual screen, in response to playing the decoded video stream, wherein the interface information includes a target object 11 and a search result 12. At step S904, the second electronic device 110 may receive an input (e.g., a user input) via the interface information related to the virtual screen. At step S905, the second electronic device 110 may transmit the user input to the first electronic device 100. At step S906, the second electronic device 110 may receive another video stream acquired according to the user input from the first electronic device 100. At step S907, the second electronic device 110 may update the interface information related to the virtual screen using the received video stream. The method of FIG. 9 may be performed by the second processor 74 of the second electronic device 110.

According to an example embodiment of the disclosure, the method performed by the first electronic device 100 comprises pausing the play of the application in response to receiving the search input. The method comprises resuming the play of the application in response to receiving feedback from the second electronic device 110 confirming acceptance of a screen cast. According to an embodiment of the disclosure, the method comprises recording (S202) the virtual screen to generate a video stream.

According to an example embodiment of the disclosure, the creating of the virtual screen comprises requesting a screen cast to the second electronic device 110. The creating of the virtual screen comprises creating the virtual screen for displaying the target object and the search result in response to receiving feedback from the second electronic device 110 confirming acceptance of the screen cast.

According to an example embodiment of the disclosure, the method comprises controlling a search function application installed in the first electronic device 100 in response to an input received from the second electronic device 110 via the interface information related to the virtual screen, wherein the virtual screen has been created by the search function application in the first electronic device 100.

According to an example embodiment of the disclosure, the method comprises displaying on the second electronic device 110, interface information related to the virtual screen, in response to playing the decoded video stream, the interface information including a target object 11 and the search result 12. The method comprises receiving an input via the interface information related to the virtual screen. The method comprises transmitting the input to the first electronic device 100. The method comprises receiving another video stream acquired according to the input from the first electronic device 100. The method comprises updating the interface information related to the virtual screen using the received video stream.

According to an example embodiment of the disclosure, the first electronic device 100 is configured to pause the play of the application in response to receiving the search input while displaying the page of the application. The first electronic device 100 is configured to resume the play of the application in response to receiving feedback from the second electronic device (110) confirming acceptance of the screen cast. According to an embodiment of the disclosure, the first electronic device 100 is configured to record the virtual screen to generate a video stream.

According to an example embodiment of the disclosure, the first electronic device 100 is configured to request a screen cast to the second electronic device 110. The first electronic device 100 is configured to create the virtual screen for displaying the target object and the search result, in response to receiving feedback from the second electronic device 110 confirming acceptance of the screen cast.

According to an example embodiment of the disclosure, the first electronic device 100 is configured to control a search function application installed in the first electronic device 100 in response to an input received from the second electronic device 110 via the interface information related to the virtual screen, wherein the virtual screen has been created by the search function application in the first electronic device 100.

According to an example embodiment of the disclosure, the first electronic device 100 may comprise at least one first memory 71 storing a computer program, wherein, when the computer program is executed by the at least one first processor 72, the at least one first processor 72 is configured to perform an operation for displaying the search result according to an embodiment of the disclosure. According to an embodiment of the disclosure, the at least one first processor 72 is configured the method comprises recording S202 the virtual screen to generate a video stream.

According to an example embodiment of the disclosure, the second electronic device 110 is configured to display, on the second electronic device 110, interface information related to the virtual screen, in response to playing the decoded video stream, wherein the interface information includes a target object and a search result. The second electronic device 110 is configured to receive an input via the interface information related to the virtual screen. The second electronic device 110 is configured to transmit the input to the first electronic device 100. The second electronic device 110 is configured to receive another video stream acquired according to the input from the first electronic device 100. The second electronic device 110 is configured to update the interface information related to the virtual screen using the received video stream.

According to an example embodiment of the disclosure, the method for displaying the search result comprises pausing the play of the first application, in response to receiving the user-triggered search operation while displaying the page of the first application. The method comprises resuming the play of the first application, in response to receiving feedback from the second electronic device 110 of determining acceptance for screen cast.

According to an example embodiment of the disclosure, the creating of the virtual screen for displaying the target object and the search result comprises requesting for the screen cast to the second electronic device 110; and creating the virtual screen for displaying the target object and the search result, in response to receiving feedback from the second electronic device 110 of determining acceptance of the screen cast.

According to an example embodiment of the disclosure, the method for displaying the search result comprises responding, by the virtual screen of the first electronic device 100, to the operation, based on the receiving of an operation of the user with respect to a video stream display interface from the second electronic device 110.

According to an example embodiment of the disclosure, the method for displaying the search result comprises receiving an operation of a user with respect to a video stream display interface, sending the operation to the first electronic device 100, and receiving and updating video stream data for display a result of the virtual screen of the first electronic device 100 responding to the operation.

According to an example embodiment of the disclosure, the first electronic device 100 for displaying a search result may comprise a virtual screen creating unit 51 configured to create a virtual screen for displaying a target object and a search result, in response to receiving a user-triggered search operation while displaying a page of a first application, a virtual screen processing unit 52 configured to record and encode the virtual screen to generate a video stream, and a virtual screen transmitting unit 53 configured to send the video stream to the second electronic device 110 for displaying the video stream on the second electronic device 110.

According to an example embodiment of the disclosure, the first electronic device 100 for displaying the search result may comprise a displaying controlling unit configured to pause the play of the first application in response to receiving the user-triggered search operation while displaying the page of the first application, and resume the play of the first application in response to receiving feedback from the second electronic device 110 of determining acceptance of the screen cast.

According to an example embodiment of the disclosure, the virtual screen creating unit 51 is configured to request a screen cast to the second electronic device 110, and create the virtual screen for displaying the target object and the search result in response to receiving feedback from the second electronic device 110 of determining acceptance for the screen cast.

According to an example embodiment of the disclosure, the first electronic device 100 may comprise an inverse controlling unit configured to respond, by the virtual screen of the first electronic device 100, to the operation, based on the receiving of an operation of the user with respect to the video stream display interface from the second electronic device 110.

According to an example embodiment of the disclosure, the second electronic device 110 for displaying a search result may comprise a video stream receiving unit 61 configured to receive a video stream related to the virtual screen, which is sent by the first electronic device 100, and a video stream playing unit 62 configured to decode and play the video stream.

According to an example embodiment of the disclosure, the second electronic device 110 may comprise an inverse controlling unit configured to receive an operation of a user with respect to a video stream display interface, send the operation to the first electronic device, and receive and update video stream data for displaying a result of the virtual screen of the first electronic device 100 responding to the operation.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method, performed by a first electronic device, for displaying a search result, the method comprising:
receiving a search input while displaying a page of an application on the first electronic device;
creating, in response to receiving the search input, a virtual screen for displaying a target object and a search result;
encoding the virtual screen to generate a video stream; and
transmitting the video stream to a second electronic device for displaying interface information related to the virtual screen on the second electronic device.

2. The method of claim 1, further comprising:
pausing, in response to receiving the search input, the play of the application; and
resuming, in response to receiving feedback from the second electronic device confirming acceptance of a screen cast, the play of the application.

3. The method of claim 1, wherein the creating of the virtual screen comprises:
requesting a screen cast to the second electronic device; and
creating the virtual screen for displaying the target object and the search result, in response to receiving feedback from the second electronic device confirming acceptance of the screen cast.

4. The method of claim 1, further comprising:
controlling a search function application installed in the first electronic device in response to an input received from the second electronic device via the interface information related to the virtual screen, wherein the virtual screen has been created by the search function application in the first electronic device,
wherein the second electronic device is controlled by a user who entered the search input.

5. The method of claim 1, further comprising displaying, on the second electronic device, the search result based on the video stream related to the virtual screen,
wherein the second electronic device is configured to:
receive, from the first electronic device, the video stream related to the virtual screen;
decode the received video stream; and
play the decoded video stream on the second electronic device.

6. The method of claim 5, wherein the second electronic device is further configured to:
display, on the second electronic device, interface information related to the virtual screen in response to playing the decoded video stream, the interface information including a target object and the search result;
receive an input via the interface information;
transmit the input to the first electronic device;
receive, from the first electronic device, another video stream acquired according to the input; and
update the interface information using the received video stream,
the second electronic device is controlled by a user who entered a search input via the first electronic device.

7. A first electronic device for displaying a search result, the first electronic device comprising:
at least one first processor, comprising processing circuitry, individually and/or collectively, configured to cause the first electronic device to:
receive a search input while displaying a page of an application on the first electronic device;
create a virtual screen displaying a target object and a search result in response to receiving the search input;
encode the virtual screen to generate a video stream; and
transmit the video stream to a second electronic device for displaying interface information related to the virtual screen on the second electronic device.

8. The first electronic device of claim 7, wherein at least one first processor, individually and/or collectively, is configured to cause the first electronic device to:
pause the play of the application in response to receiving the search input while displaying the page of the application; and
resume the play of the application in response to receiving feedback from the second electronic device confirming acceptance of the screen cast.

9. The first electronic device of claim 7, wherein at least one first processor, individually and/or collectively, is configured to cause the first electronic device to:
create the virtual screen,
request a screen cast to the second electronic device; and
create the virtual screen displaying the target object and the search result in response to receiving feedback from the second electronic device confirming acceptance of the screen cast.

10. The first electronic device of claim 7, wherein at least one first processor, individually and/or collectively, is configured to cause the first electronic device to:
control a search function application installed in the first electronic device in response to an input received from the second electronic device via the interface information related to the virtual screen, wherein the virtual screen has been created by the search function application in the first electronic device.

11. The first electronic device of claim 7, wherein the first electronic device further comprises:
at least one memory storing a computer program, wherein, when the computer program is executed by the at least one first processor, individually and/or collectively, the first electronic device is configured to perform the operation for displaying the search result according to claim 7,
the second electronic device is configured to be controlled by a user who entered the search input.

12. The first electronic device of claim 7 wherein the second electronic device comprising:
at least one second processor, comprising processing circuitry, individually and/or collectively, configured to cause the second electronic device to:
receive, from the first electronic device, the video stream related to the virtual screen;
decode the received video stream; and
play the decoded video stream on the second electronic device.

13. The first electronic device of claim 12, wherein at least one second processor, individually and/or collectively, is configured to cause the second electronic device to:
display, on the second electronic device, the interface information related to the virtual screen, in response to playing the decoded video stream, wherein the interface information includes a target object and a search result;
receive an input via the interface information;
transmit the input to the first electronic device;
receive, from the first electronic device, another video stream acquired according to the input; and
update the interface information using the received video stream, wherein the second electronic device is controlled by a user who entered a search input via the first electronic device.

14. A non-transitory computer-readable storage medium storing a computer program, which, when executed by at least one first processor, comprising processing circuitry, individually and/or collectively, of a first electronic device, causes the first electronic device to perform the method according to claim 1.

15. The non-transitory computer-readable storage medium of claim 14, wherein the computer program, when executed, causes the first electronic device to perform the method according to claim 2.

16. The non-transitory computer-readable storage medium of claim 14, wherein the computer program, when executed, causes the first electronic device to perform the method according to claim 3.

17. The non-transitory computer-readable storage medium of claim 14, wherein the computer program, when executed, causes the first electronic device to perform the method according to claim 4.

18. The non-transitory computer-readable storage medium of claim 14, wherein the computer program, when executed, causes the first electronic device to perform the method according to claim 5.

19. The non-transitory computer-readable storage medium of claim 14, wherein the computer program, when executed, causes the first electronic device to perform the method according to claim 6.
